(19) United States
(12) Patent Application Publication
(10) Pub. No.: US 2002/0160902 A1
(43) Pub. Date: Oct. 31, 2002

(54) Composite material based on silicon carbide and carbon, process for its production and its use

(76) Inventors: Christoph Lesniak, Buchenberg (DE); Lorenz Sigl, Lechaschau (AT); Armin Kayser, Buchenberg (DE)

Correspondence Address: COLLARD & ROE, P.C., 1077 Northern Boulevard, Roslyn, NY, 11576-1696, US

(21) Appl. No.: 10/093,780

(22) Filed: Mar. 7, 2002

(30) Foreign Application Priority Data
Mar. 8, 2001 (DE) 101 11 225.4

(51) Int. Cl. C04B 35/565; C04B 35/52

(52) U.S. Cl. 501/90; 501/88

(57) ABSTRACT

A ceramic composite material with a density of >90% of the theoretical density based on SiC and carbon, with a silicon carbide content of between 99.9% by weight and 70% by weight and a carbon content of between 0.1% by weight and 30% by weight, the SiC having a microstructure with a bimodal grain structure, has

(a) the mean grain size of all SiC grains is >10 μm,

(b) the bimodal equiaxial grain structure of the SiC microstructure is formed from a fine grain fraction, with a mean grain size of <10 μm and in an amount of between 10 and 50 percent by area, and a coarse grain fraction, with a mean grain size of between 10 and 1000 μm and in an amount of between 50 and 90 percent by area, in each case measured on a polished, planar ceramographic section, and

(c) the carbon has a mean grain size of <10 μm.

### BACKGROUND OF THE INVENTION

1. Field of the Invention

The present invention relates to a composite material based on silicon carbide and carbon, to a process for its production and to its use.

2. The Prior Art

Compact sintered SiC is distinguished by a high hardness, an ability to withstand high temperatures, high thermal conductivity, resistance to thermal shocks and oxidation, and a high resistance to abrasion and corrosion. Furthermore, it has particularly good tribological properties, which are to be understood as meaning the friction and wear performance with and without lubrication. For this reason, sintered SiC has become accepted as a virtually ideal material for sliding-contact bearings which are subject to wear, and in particular mechanical seals. Sintered SiC has displaced other materials, such as for example aluminum oxide or hard metal, in these applications. Even since the end of the 1970s, mechanical seals and sliding-contact bearings made from sintered silicon carbide (SSiC) have been used successfully in pumps, which are subject to high corrosion and abrasive wear. Compact sintered SiC has a high purity, of typically ³ 98% by weight of SiC, and a sintered density of typically >3.10 g/cm³, corresponding to a residual porosity of <3% by volume. On account of its high hardness, sintered SiC is extremely resistant to wear from solid particles which are entrained in liquid media. Even in the event of a combination of abrasive and corrosive wear, this ceramic material remains resistant. On account of the universal resistance to corrosion, the extremely high resistance to wear and the good tribological properties, densely sintered SiC has been able to solve a multiplicity of bearing and sealing problems.

Many sliding wear problems which occur in practice can be traced back to interruption of the ideal, i.e. correctly lubricated, running conditions. In such instances, the sliding surfaces of the corresponding bearings or seals come into contact with one another, and solid-state or dry friction occurs. This manifests itself as a greatly increased coefficient of friction and leads to temperature peaks.

Pure SiC is not optimally suited for use under difficult conditions of this nature. For these applications, modified SiC materials have been developed, which, by means of a suitable configuration of the functional surfaces, ensure sufficient stabilization of the hydrodynamic lubricating film even in the event of brief mixed-friction and dry running. Various SiC materials with pores which are introduced in a defined way are known from the patent literature.

For example, DE 3,927,300 (corresponds to U.S. Pat. No. 5,080,378) has disclosed porous SSiC with from 4 to 14% by volume of spherical macropores with a mean pore size of from 10 to 40 μm. EP 486,336 (corresponds to U.S. Pat. No. 5,610,110) describes a porous SSiC with from 4 to 18% by volume of spherical macropores with a mean pore size of from 60 to 200 mm. U.S. Pat. No. 5,395,807 reveals a process for producing coarse-pored SSiC, which has from 2 to 12% by volume of spherical pores with a pore size of between 50 and 500 μm. EP 685,437 (corresponds to U.S. Pat. No. 5,762,895), for its part, describes a sliding material comprising porous SiC with a trimodal pore composition with from 3 to 10% by volume of closed pores. In all the abovementioned SSiC materials, the pores act as lubricating micropockets in the sliding surface. In the event of a brief absence of the hydrodynamic lubricating film, these micropockets mean that residual lubrication is still possible.

Furthermore, it is known that, by introducing microstructural constituents which act as a solid lubricant, e.g. graphite or hexagonal boron nitride, it is possible to achieve a considerably improved running performance in dynamic mechanical seals. This behavior applies in particular in what are known as hard/hard pairings (mechanical seals in which an SiC sliding ring runs against an SiC mating ring) which, in the event of high pressure differences, run under mixed and limit friction conditions. Materials which comprise SiC and solid-lubricating microstructural constituents, as well as processes for their production, have been described numerous times in patent literature.

U.S. Pat. No. 4,525,461 describes a material comprising SiC graphite and carbon containing from 1 to 13% of graphite, which is distinguished by a fine-grained SiC and graphite microstructure, i.e. by an SiC and graphite grain size which is £ 10 μm for both constituents of the microstructure.

DE 3,329,225 has disclosed a sliding material based on SiC with from 1 to 10% by volume of BN, graphite and/or carbon black and a mean SiC grain size of £ 200 μm, in which the second phase is dispersed only along the SiC grain boundaries. This material preferably has a mean SiC grain size of £ 50 μm, and contains from 5 to 10% by volume of graphite.

EP 709,352 discloses a virtually pore-free shaped body which comprises SiC (³ 95% of the theoretical density) and 7 to 30% by volume of solid lubricant, in the form of graphite, carbon black or BN, in which the solid lubricant has a grain size of >20 to 500 μm, and the proportion of solid lubricant with a grain size of >100 μm amounts to at least 5% by volume of the shaped body.

WO 94/18141 (corresponds to U.S. Pat. No. 5,656,563) describes a process for producing SiC materials with a sintered density of ³ 80% of the theoretical density, with a mean SiC grain size of from 2 to 15 μm, a mean graphite grain size of from 10 to 75 μm, and with the graphite grain size always being greater than the SiC grain size.

WO 95/23122 (corresponds to U.S. Pat. No. 5,580,834) describes a SiC material which is sintered without the use of pressure and comprises from 5 to 50% of graphite and 8 to 30% of pores, which are subsequently impregnated with a carbon precursor, resin, Teflon or metals. These porous SiC materials have a preferred sintered density of from 2.10 to 2.60 g/cm³ and comprise 50 to 95% of SiC with a mean grain size of from 10 to 25 μm and 50 to 5% of carbon, with a mean grain size of from 75 to 125 μm.

U.S. Pat. No. 5,639,407 has disclosed a porous SSiC comprising from 5 to 20% of graphite with a sintered density of at least 2.8 g/cm³ and a flexural strength of >180 MPa, the graphite particles having a mean grain size of ³ 100 μm.

The SiC material variants described, with incorporated solid-lubricating constituents for tribological applications, have various drawbacks. A particular problem is that the fine-grained SiC materials described, on account of their high specific grain boundary surface area, have a reduced resistance to corrosion in aqueous media, particularly if they are used in aqueous media at elevated temperature, e.g. in hot water.

Moreover, SiC materials which contain large quantities of coarse-grained solid lubricant particles, for example in the form of particulate carbon or boron nitride, are difficult to process using the known powder technology process steps. The process engineering drawbacks commence during pressing, during which coarse solid particles increase the likelihood of cracks forming in the green body when the load is relieved after the pressing operation, on account of their ability to spring open, which differs from that of SiC granules (cf. Comparative Example 2). During sintering, the solid particles impede the shrinkage of the body during the sintering process and, as a result, make the production of sintered bodies with a small amount of pores more difficult, if not impossible. Both effects cause considerable problems for the production of inexpensive SiC sintered bodies with solid lubricating particles.

### SUMMARY OF THE INVENTION

Working on the basis of the prior art which has been presented, it is an object of the present invention to provide a ceramic composite material which has a density of >90% of the theoretical density, is based on SiC and carbon and does not have the drawbacks described above.

The above object is achieved according to the present invention by a ceramic composite material having a silicon carbide content of between 99.9% by weight and 70% by weight and a carbon content of between 0.1% by weight and 30% by weight, in which the SiC has a microstructure with a bimodal grain structure, wherein the % by weight of SiC and carbon is based upon the total weight of the ceramic composite material;

(a) the mean grain size of all SiC grains amounts to a mean grain size of >10 μm,

(b) the bimodal grain structure of the SiC microstructure is formed from an equiaxial fine grain fraction, with a mean grain size of <10 μm and in an amount of between 10 and 50 percent by area, and a coarse grain fraction, with a mean grain size of between 10 and 1000 μm and in an amount of between 50 and 90 percent by area, in each case measured on a polished, planar ceramographic section, and wherein

(c) the carbon has a mean grain size of <10 μm.

In the context of the present invention, particles with an aspect ratio of from 1:1 to 1:2 are preferably equiaxial.

All the details relating to the grain size in the shaped body according to the invention were determined using the intersected segment method. The relative density is defined as the ratio between the actual density and the maximum density which is theoretically possible. Particles with a grain size of >10 μm are defined as coarse-grained.

The equiaxial fine grain fraction preferably has a size distribution of the SiC particles of between 0.5 and 15 μm. The SiC coarse grain fraction preferably comprises plateletlike grains with an aspect ratio of >3, preferably >5, so that these grains are anchored in the interior of the microstructure. The specific grain boundary surface area is reduced by the coarse grains of the microstructure, so that the surface areas available for attack by electrochemical corrosion are reduced in size. The SiC coarse grain fraction preferably has a maximum grain size of 1500 μm.

The carbon particles are preferably of equiaxial form and are preferably arranged at the SiC grain boundaries (intergranular arrangement) or in the interior of SiC grains (intragranular arrangement). The bonding of the carbon in the surrounding SiC matrix is so great that the inclusions resist being torn out even under severe mechanical loads, as occur, for example, during machining (lapping, grinding, ultrasound) or during component loading and remain securely bonded in the microstructure.

The carbon content in the composite material according to the invention is preferably between 2 and 10% by weight, particularly preferable between 5 and 8% by weight. It is also preferably if the carbon content is >13% by weight up to 30% by weight. The carbon is preferably graphite.

A characteristic feature of this carbon is that it is generally in the form of crystalline graphite, with a mean grain size which is smaller than the mean grain size of the coarse grain fraction of the SiC microstructure and preferably corresponds to the mean grain size of the fine grain fraction of the SiC microstructure.

The composite material according to the invention preferably has a relative density of >93% of the theoretical density, particularly preferably >95% of the theoretical density. The theoretical density can in this case be calculated from the linear mixing rule, taking account of all the components which are present in the sintered body (SiC, graphite, amorphous carbon, sintering aids).

The material according to the invention combines the advantages of solid lubrication by carbon particles with an improvement in the corrosion resistance by means of a reduced specific SiC grain boundary surface area on account of the increased SiC grain size. By using a fine-grained solid lubricant in the form of fine-grained carbon, it avoids the abovementioned process engineering drawbacks during production, i.e. during pressing and sintering. On the other hand, the advantages of the solid-state lubricant are retained despite the fine-grained nature of the carbon.

The material according to the invention is produced, for example, in the following way: an aqueous slip is produced from a crystalline SiC powder (α- or β-SiC) and water, to which slip a carbon carrier, e.g. graphite powder or graphite precursors, is added in a concentration which is such that between 1 and 30% by weight of carbon is present in the finished sintered body, and the sintering aids and, if appropriate, organic auxiliaries which are customary for pressure-free sintering of SiC are added in the usual quantities. Granules are produced from this slip using a standard granulation method, such as for example spray drying, and a shaped body, which is sintered without the use of pressure in order to establish the desired microstructure in accordance with the invention, is produced from the granules using known shaping techniques.

The preparation of the slip with water is used deliberately for optimal homogenization or uniform distribution of the various components.

Surprisingly, it has been found that, under the sintering conditions required for production of a bimodal SiC microstructure, the particulate carbon does not inhibit sintering, and the SiC carbon composite material according to the invention can be produced with a high relative density by pressure-free sintering.

By selecting suitable sintering conditions, it is possible to produce shaped bodies with a virtually pore-free, bimodal SiC microstructure according to the invention, into which the carbon particles are securely bonded (intergranular and intragranular), by pressure-free sintering. Suitable sintering conditions are characterized by the fact that the shaped bodies, from which binder has been removed and which have been cooled to room temperature, are placed into graphite crucibles, which in turn are introduced into the heating zone of a graphite tube furnace. These graphite crucibles are preferably heated, under a reduced pressure of between 100 and 980 mbar, with a heating rate of between 25 and 500° C./h, to a sintering temperature of ≧2100° C. and are held at this temperature for between 15 and 120 min. During the sintering, it is ensured that the microstructure does not become excessively coarse. The mean grain size of the coarse grain fraction is preferably <200 μm.

The starting material used for the production of the material according to the invention is a crystalline SiC powder (α- or β-SiC) with a high purity (>95%) and a high specific surface area, preferably >5 m²/g. This powder is processed into a low-viscosity SiC slip with a high solids content using conventional dispersion techniques, such as for example stirring, ultrasound dispersion or even by milling, and inorganic sintering aids from the second or third main group of the periodic system (boron or boron compounds, such as for example B₄C; aluminum or aluminum compounds, such as for example AlN; beryllium compounds, such as for example Be₂C) in the form of fine powders (specific surface area preferably >1 m²/g) are preferably added to this slip in concentrations of between 0.1% by weight and 2.0% by weight. The concentration of B, Al or Be is preferably <1.0% by weight, particularly preferably between 0.2 and 0.7% by weight.

According to the invention, the solid lubricant used is a carbon powder, generally in the form of graphite, which has a primary grain size of <10 μm. The carbon powder is worked into the slip, during which process the hydrophilic nature of the carbon surface, using a standard dispersing technique, allows homogeneous distribution in the slip, so that ultimately a homogeneous distribution of the carbon in the sintered body is achieved.

The carbon is added to the aqueous SiC slip in the desired quantity and is worked in by standard mixing techniques (stirring, high-energy stirring or ultrasound treatment). As an alternative to these methods, the mixture may also be homogenized by milling, preferably by autogeneous milling, i.e. using milling containers and milling bodies made from SiC.

Moreover, the organic aids which are customary for further production steps, such as binders (e.g. polyvinyl alcohol), plasticizers (e.g. organic fatty acids) and a carbon donor (e.g. carbohydrates, phenolic resin, highly dispersed carbon black), which provides the carbon required in order to reduce the SiO₂ layer present on the SiC grains, are worked into the base slip, comprising SiC, inorganic sintering aid and carbon obtained in this way.

For shaping by dry pressing, the slip is spray-dried, since in this way the homogeneous carbon distribution in the SiC is stabilized and long storage times become possible. Known pressing processes, such as uniaxial pressing or cold isostatic pressing, are used to produce a shaped body from the granules obtained in this way. Then, this shaped body is subjected to a standard heat treatment at temperatures of <1000° C. in an inert or reducing atmosphere (pyrolysis), with the result that the amorphous carbon for reducing the SiO₂ layers is formed from the C precursors. The pyrolized shaped bodies are then sintered.

Careful monitoring of the sintering conditions is required in order to obtain the microstructure according to the invention with the bimodal SiC grain distribution and the homogeneously distributed inclusions of carbon during sintering. These preferred sintering conditions are as follows: the binder-free shaped bodies are heated in graphite crucibles, under a reduced pressure of between 100 and 950 mbar, with a heating rate of between 25 and 500° C./h, to a sintering temperature of between 2100° C. and 2150° C., and are held at this temperature for between 15 and 120 min. Under these sintering conditions, the desired microstructure according to the invention is developed. This is distinguished by the fact that less than 50 percent by area consists of SiC grains with a mean grain size of <10 μm, while the remainder consists of larger, plateletlike SiC crystals with a mean grain size of between 10 and 1000 μm. The microstructure is also distinguished by the fact that the carbon which is introduced is homogeneously distributed in the microstructure; the individual carbon particles may be both at the SiC grain boundaries and included in the interior of plateletlike SiC crystallites. The good bonding of the carbon into the SiC matrix means that the surface of the material is able to withstand even intensive mechanical/tribological loads and an ultrasound treatment.

On account of the particular microstructure of the SiC/carbon composite material according to the invention which has been described, the material is particularly suitable for tribological applications under high loads, and also in tribologically complex situations. It is particularly suitable for applications in which corrosive attack from hot water in combination with high pressures occurs.

The SiC/carbon composite materials according to the invention are therefore particularly suitable for production of a component for a sealing application, preferably a mechanical seal. In particular, the material is suitable as a sliding ring and mating ring in hard/hard pairings of mechanical seals. These materials are particularly preferred for applications in which corrosive attack by hot water in combination with high pressures occurs.

The material according to the invention is particularly suitable for the production of components which are used in pumps and seals where the fluid to be conveyed comprises >95% of water, preferably water at a temperature of >70° C. The material according to the invention is also suitable for the production of a sliding-contact bearing.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention. In the drawings:

FIG. 1a shows a longitudinal section through an SiC-graphite composite material containing 7 parts by weight of graphite KS6, unetched sections;

FIG. 1b shows a longitudinal section through an SiC-graphite composite material containing 7 parts by weight of graphite KS6, etched according to Murakami;

FIG. 1c shows a longitudinal section through an SiC-graphite composite material containing 7 parts by weight of graphite KS6, etched in accordance with Murakami;

FIG. 2 shows a longitudinal section through an SiC-graphite composite material containing 7 parts by weight of graphite KS5-75, unetched;

FIG. 3a shows a longitudinal section through an SiC-graphite composite material containing 15 parts by weight of graphite KS6, unetched; and

FIG. 3b shows a longitudinal section through an SiC-graphite composite material containing 15 parts by weight of graphite KS6, etched in accordance with Murakami.

### DETAILED DESCRIPTION OF PREFERRED EMBODIMENTS

### EXAMPLE 1

Production of a shaped body with a bimodal microstructure and a low graphite content (<10% by weight) using a fine-grained graphite (maximum grain size <10 μm).

A fine-grained SiC with a particle size d₅₀ of 0.65 μm, a BET specific surface area of 12.5 m²/g and a residual oxygen content of 0.6% by weight is used to produce a slip with a solids content of 65% by weight using deionized water which has been adjusted to pH 9 by the addition of ammonia. 0.64 parts by weight of B₄C, based on SiC, are added with constant stirring using a blade stirrer, and the mixture is homogenized for 5 minutes in a forced mixer (“Ultraturrax” mixer; IKA GmbH & Co. KG, D-79217 Staufen). Then, 7 parts by weight of graphite KS6 (commercially available from Timcal, CH-5643 Sins, Switzerland) with a maximum particle size of 10 μm and a mean particle size of 5 μm are then added to this base slip, followed once again by homogenization for 5 minutes using the forced mixer. 2.5 parts by weight of sugar as C donor and a mixture of polyvinyl alcohol (1 part by weight) and Zusoplast® (2 parts by weight) as binder/pressing aid are added to this slip. The blade stirrer is used to homogenize the slip for a further 15 minutes. Granules with a mean granule size of 70 μm are produced from the slip by spray drying in air.

Die pressing at 100 MPa produces a shaped body which has a pressed density of 1.80 g/cm³. The pressed parts are heat-treated in a coking furnace in order to gently remove the organic auxiliaries and to pyrolyse the carbon donor sugar, for 12 hours at 800° C. under flowing argon. The shaped bodies from which binder has been removed are cooled to room temperature, then introduced into a graphite tube furnace and finally sintered without the use of pressure for 30 min at 2140° C., under an argon pressure of 20 mbar. After cooling, the sintered bodies have a density of 3.07 g/cm³, which corresponds to 99% of the theoretical density. During sintering, the sintered bodies have undergone linear shrinkage of 17.5%.

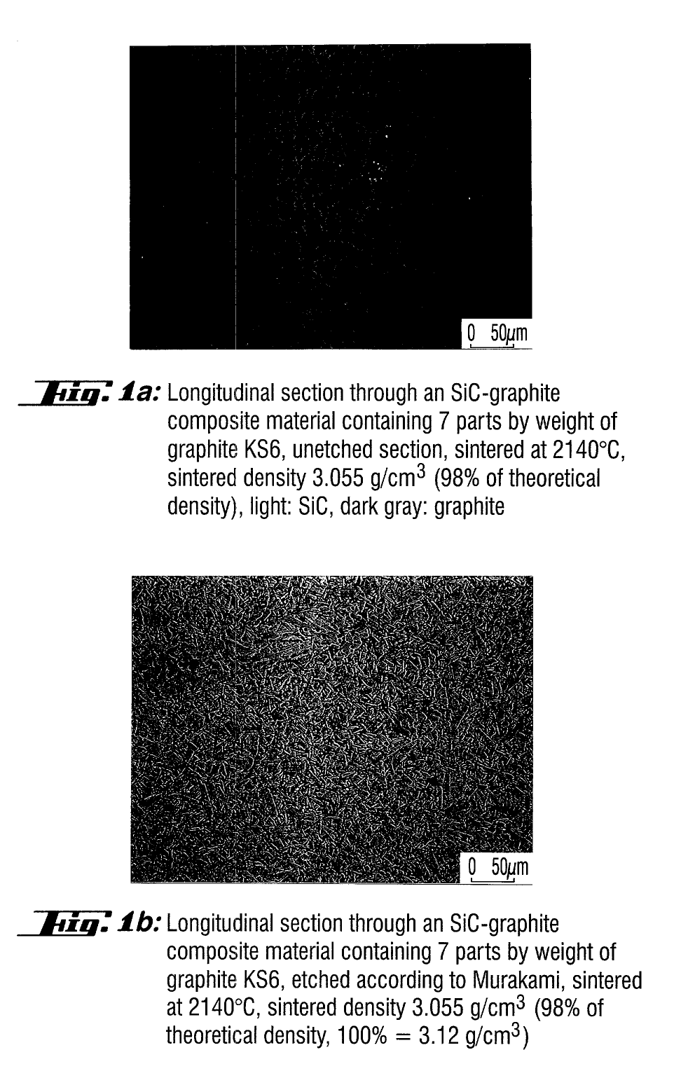

A typical form of the microstructure of Example 1 is illustrated in FIGS. 1a and 1b. FIG. 1a shows a micrograph of a polished, unetched section. The microstructure overall is very dense and free of pores which are larger than 30 μm. FIG. 1a provides evidence that the graphite particles are distributed uniformly and homogeneously in the microstructure and have a mean grain size of <10 μm. There is no evidence of any cracks at all around the graphite particles.

FIG. 1b shows a micrograph of a polished section of the same material which has been etched with Murakami solution. The bimodal microstructure can be clearly seen; the coarse grain fraction is in platelet form and makes up more than 50% by area of the SiC microstructure and has a mean grain size of >10 μm (cf. Table 1). The fine grain fraction is of equiaxial form and has a mean grain size <10 μm. Moreover, it can be seen from FIG. 1b that the graphite particles are located both at the SiC grain boundaries and in the interior of SiC grains. The result of the microstructural analysis according to grain size classes is illustrated in Table 1.

Table 1:

Frequency distribution of the SiC grain sizes (measured using the intersected segment method)

| | Example 1 | Example 3 |
|---|---|---|
| Grain size class | Surface frequency | Surface frequency |
| [μm] | [%] | [%] |
| 0-10 | 31 | 45 |
| 10-20 | 39 | 42 |
| 20-30 | 17 | 8 |
| 30-40 | 11 | 4 |
| >40 | 2 | 1 |

The largest grains of the coarse grain fraction are not recorded in this analysis. These grains can be seen from FIG. 1c. They further increase the coarse grain fraction of the material according to the invention. FIG. 1c very clearly shows the altogether unexpected grain boundary growth which has taken place despite the addition of carbon.

### EXAMPLE 2

Production of a shaped body with bimodal microstructure and a low graphite content (<10% by weight) using a coarse-grained graphite (>20 μm).

A fine-grained SiC with a particle size d₅₀ of 0.65 μm, a BET specific surface area of 12.5 m²/g and a residual oxygen content of 0.6% by weight is used to produce a slip with a solids content of 65% by weight using deionized water which has been adjusted to pH 9 by the addition of ammonia. 0.64 parts by weight of B₄C, based on SiC, are added with constant stirring using a blade stirrer, and the mixture is homogenized for 5 minutes in a forced mixer (“Ultraturrax” mixer; IKA). Then, 7 parts by weight of graphite K5-75 (Timcal) with a maximum particle size of 100 μm and a mean particle size of approximately 40 μm are then added to this base slip, followed once again by homogenization for 5 minutes using the forced mixer. 2.5 parts by weight of sugar as C donor and a mixture of polyvinyl alcohol (1 part by weight) and Zusoplast® (2 parts by weight) as binder/pressing aid are added to this slip. The blade stirrer is used to homogenize the slip for a further 15 minutes. Granules with a mean granule size of 70 μm are produced from the slip by spray drying in air.

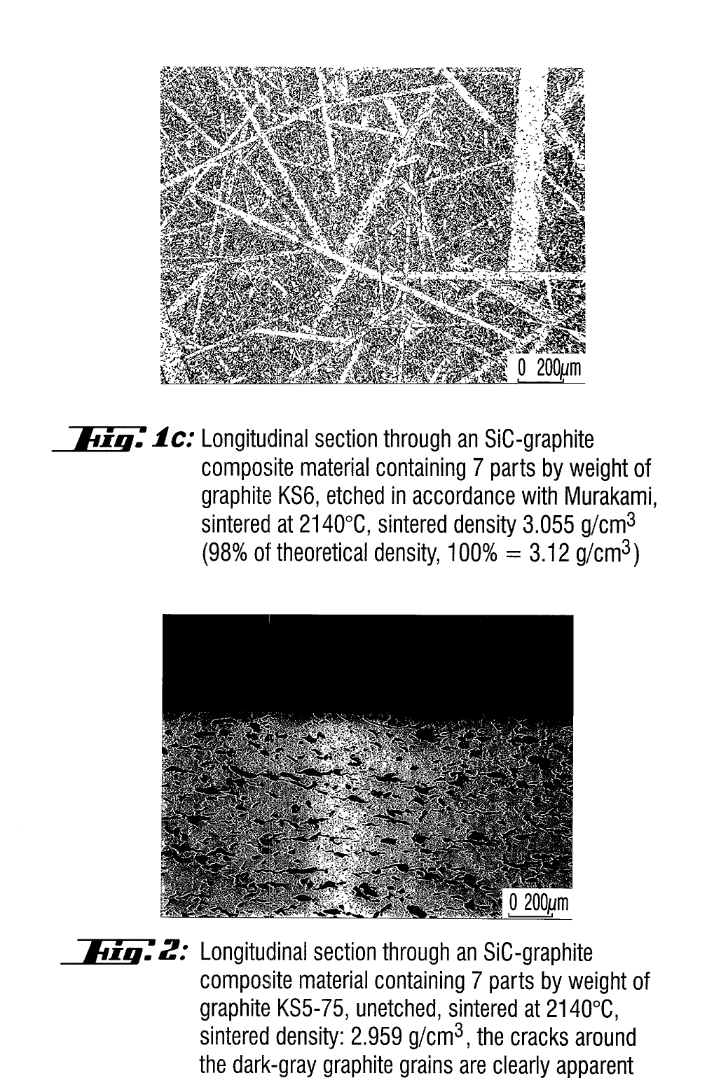

Die pressing at 100 MPa produces a shaped body which has a pressed density of 1.81 g/cm³. The pressed parts are heat-treated in a coking furnace in order to gently remove the organic auxiliaries and to pyrolyse the carbon donor sugar, for 12 hours at 800° C. under flowing argon. The shaped bodies from which binder has been removed are cooled to room temperature, then introduced into a graphite tube furnace and finally sintered without the use of pressure for 30 min at 2140° C., under an argon pressure of 20 mbar. After cooling, the sintered bodies have a density of 2.959 g/cm³, which corresponds to 94.2% of the theoretical density. FIG. 2 shows a ceramographic section of a polished cross section. The cracks which have formed around the coarse graphite particles are clearly apparent.

### EXAMPLE 3

Production of a shaped body with bimodal microstructure and a high graphite content (>10%) using a fine-grained graphite (<10 μm).

A fine-grained SiC with a particle size d₅₀ of 0.65 μm, a bet specific surface area of 12.5 m²/g and a residual oxygen content of 0.6% by weight is used to produce a slip with a solids content of 65% by weight using deionized water which has been adjusted to pH 9 by the addition of ammonia. 0.64 parts by weight of B₄C, based on sic, are added with constant stirring using a blade stirrer, and the mixture is homogenized for 5 minutes in a forced mixer (“Ultraturrax” mixer; ika). Then, 15 parts by weight of graphite KS6 (Timcal) with a maximum particle size of 10 μm and a mean particle size of approximately 5 μm are then added to this base slip, followed once again by homogenization for 5 minutes using the forced mixer. 2.5 parts by weight of sugar as C donor and a mixture of polyvinyl alcohol (1 part by weight) and Zusoplast® (2 parts by weight) as binder/pressing aid are added to this slip. The blade stirrer is used to homogenize the slip for a further 15 minutes. Granules with a mean granule size of 70 μm are produced from the slip by spray drying in air.

Die pressing at 100 mPa produces a shaped body which has a pressed density of 1.78 g/cm³. The pressed parts are heat-treated in a coking furnace in order to gently remove the organic auxiliaries and to pyrolyse the carbon donor sugar, for 12 hours at 800° C. under flowing argon. The shaped bodies from which binder has been removed and which have been cooled to room temperature are then sintered in graphite crucibles, which are introduced into the heating zone of a graphite tube furnace, at 2175° C. for 30 min under a vacuum of 20 mbar. After cooling, the sintered bodies have a density of 2.855 g/cm³, which corresponds to 94% of the theoretical density.

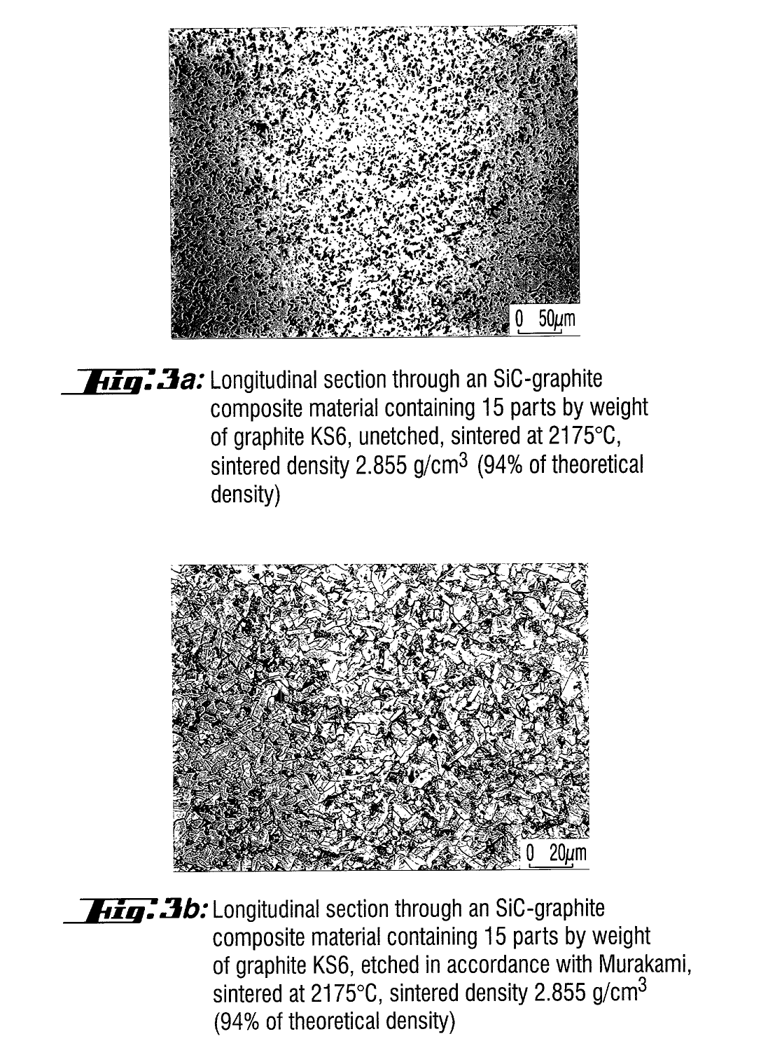

FIG. 3a shows a polished, unetched ceramographic section of the material. FIG. 3b shows an etched section (Murakami solution) to illustrate the form of the SiC microstructure. The microstructure is free of pores which are >50 μm. The graphite is homogeneously distributed in the sintered body and is located primarily at the SiC grain boundaries. The bimodal SiC microstructure is clearly apparent from the etched section. The result of the microstructure analysis according to grain size classes is given in Table 1.

Accordingly, while a few embodiments of the present invention have been shown and described, it is to be understood that many changes and modifications may be made thereunto without departing from the spirit and scope of the invention as defined in the appended claims.

What is claimed is:

1. A ceramic composite material with a density of >90% of the theoretical density based on SiC and carbon comprising a silicon carbide content of between 99.9% by weight and 70% by weight and a carbon content of between 0.1% by weight and 30% by weight, the SiC having a microstructure with a bimodal grain structure;
wherein the % by weight of SiC and carbon is based upon the total weight of the ceramic composite material;
(a) a mean grain size of all SiC grains is >10 μm;
(b) the bimodal grain structure of the SiC microstructure is formed from an equiaxial fine grain fraction, with a mean grain size of <10 μm and in an amount of between 10 and 50 percent by area, and a coarse grain fraction, with a mean grain size of between 10 and 1000 μm and in an amount of between 50 and 90 percent by area, said area in each case measured on a polished, planar ceramographic section, and wherein
(c) the carbon has a mean grain size of <10 μm.

2. The ceramic composite material as claimed in claim 1,
wherein the SiC coarse grain fraction comprises plateletlike grains with an aspect ratio of >3.

3. The ceramic composite material as claimed in claim 1,
wherein the carbon particles are of equiaxial form and are arranged selected from the group consisting of at the SiC grain boundaries (inter granular arrangement), and in the interior of SiC grains (intragranular arrangement).

4. The ceramic composite material as claimed in claim 1,
wherein the relative density of the composite material is >93% of the theoretical density.

5. The ceramic composite material as claimed in claim 1,
wherein the relative density of the composite material is >95% of the theoretical density.

6. The ceramic composite material as claimed in claim 1,
wherein the carbon content is between 2% and 10% by weight.

7. The ceramic composite material as claimed in claim 1,
wherein the carbon content is between 5 and 8% by weight.

8. The ceramic composite material as claimed in claim 1,
wherein the carbon content is >13 up to 30% by weight.

9. The ceramic composite material as claimed in claim 1,
wherein the carbon content consists of graphite.

10. The ceramic composite material as claimed in claim 9,
wherein the carbon is in the form of crystalline graphite and has a mean grain size which is smaller than a mean grain size of a coarse grain fraction of the SiC microstructure.

11. The ceramic composite material as claimed in claim 9,
wherein the carbon is in the form of crystalline graphite and has a mean grain size which corresponds to the mean grain size of the fine grain fraction of the SiC microstructure.

12. A process for producing a ceramic composite material, comprising
producing an aqueous slip from a crystalline SiC powder and water, to which slip a carbon carrier is added in a concentration which is such that between 1 and 30% by weight of carbon is present in the finished sintered body;
adding sintering aids and, if appropriate, organic auxiliaries which are customary for pressure-free sintering of SiC in usual quantities;
producing granules from this slip using a standard granulation method;
and producing a shaped body, which is sintered without the use of pressure in order to establish a desired microstructure from the granules using known shaping techniques.

13. In a method for the production of a component which is used in a pump or a seal, the improvement which comprises utilizing the ceramic composite material as claimed in claim 1, for said component.

14. In a method for the production of a mechanical seal, the improvement which comprises utilizing the ceramic composite material as claimed in claim 1, for said mechanical seal.

15. In a method for producing a mechanical seal, having a sliding ring and a mating ring made from the same material, the improvement which comprises utilizing the ceramic composite material as claimed in claim 1 for said mechanical seal.

16. In a method for the production of a sliding-contact bearing, the improvement which comprises utilizes the ceramic composite material as claimed in claim 1 for said bearing.
